(19) United States
(12) Patent Application Publication
(10) Pub. No.: US 2023/0004229 A1
(43) Pub. Date: Jan. 5, 2023

(54) ITEM SELECTION WITH SMART DEVICE MONITORING OF GESTURES

(71) Applicant: International Business Machines Corporation, Armonk, NY (US)

(72) Inventors: Venkata Vara Prasad Karri, Visakhapatnam (IN); Kiruthikalakshmi Periasamy, Erode (IN); Sarbajit K. Rakshit, Kolkata (IN); Hemant Kumar Sivaswamy, Pune (IN)

(21) Appl. No.: 17/363,388

(22) Filed: Jun. 30, 2021

(51) Int. Cl. G06F 3/01; G06F 16/55; G06K 9/00; G06F 3/14; G06F 3/0482

(52) U.S. Cl. CPC G06F 3/017; G06F 16/55; G06K 9/00355; G06F 3/1423; G06F 3/0482; G06Q 30/0643

(57) ABSTRACT

A system may monitor an appendage gesture with a smart device, extrapolate a gesture direction, select an item on a display based on the gesture direction, and display the item on a second display on the smart device.

### BACKGROUND

Aspects of the present disclosure relate to smart devices, more particular aspects relate to item selection with smart device monitoring of gestures.

A smart device is an electronic device, generally connected to other devices or networks via different wireless protocols that can operate to some extent interactively and autonomously. Several notable types of smart devices are smartphones, phablets and tablets, smartwatches, smart bands, smart key chains, and others.

### BRIEF SUMMARY

The present disclosure provides a method, computer program product, and system of item selection with smart device monitoring of gestures. In some embodiments, the method includes monitoring an appendage gesture with a smart device, extrapolating a gesture direction, selecting an item on a first display based on the gesture direction, and displaying the item on a second display on the smart device.

Some embodiments of the present disclosure can also be illustrated by a computer program product comprising a computer readable storage medium having program instructions embodied therewith, the program instructions executable by a processor to cause the processors to perform a method, the method comprising monitoring an appendage gesture with a smart device, extrapolating a gesture direction, selecting an item on a first display based on the gesture direction, and displaying the item on a second display on the smart device.

Some embodiments of the present disclosure can also be illustrated by a system comprising a processor and a memory in communication with the processor, the memory containing program instructions that, when executed by the processor, are configured to cause the processor to perform a method, the method comprising monitoring an appendage gesture with a smart device, extrapolating a gesture direction, selecting an item on a first display based on the gesture direction, and displaying the item on a second display on the smart device.

### BRIEF DESCRIPTION OF THE DRAWINGS

FIG. 1 depicts example gesture system according to various embodiments of the present invention.

FIG. 2 illustrates an example method of item selection using gestures for displayed items, according to various embodiments of the present invention.

FIG. 3 depicts a computer system according to various embodiments of the present invention.

### DETAILED DESCRIPTION

Aspects of the present disclosure relate to smart devices; more particular aspects relate to item selection with smart device monitoring of gestures. While the present disclosure is not necessarily limited to such applications, various aspects of the disclosure may be appreciated through a discussion of various examples using this context.

People spend an immense amount of time in front of displays. From movies at home to games on the computer, a large amount of exposure to new products and other interesting items occurs through digital media. However, there is a need for a user-friendly method of selecting items on a display for a smart lookup without disturbing other users who are also watching the display.

Therefore, a system and method for using a smart device to monitor user gestures, and thereby identify on-display items, is proposed. In some embodiments, the system may implement a smart lookup to find identified items using associated internet resources (e.g., product pages for purchase, informational websites, locations, or even directions).

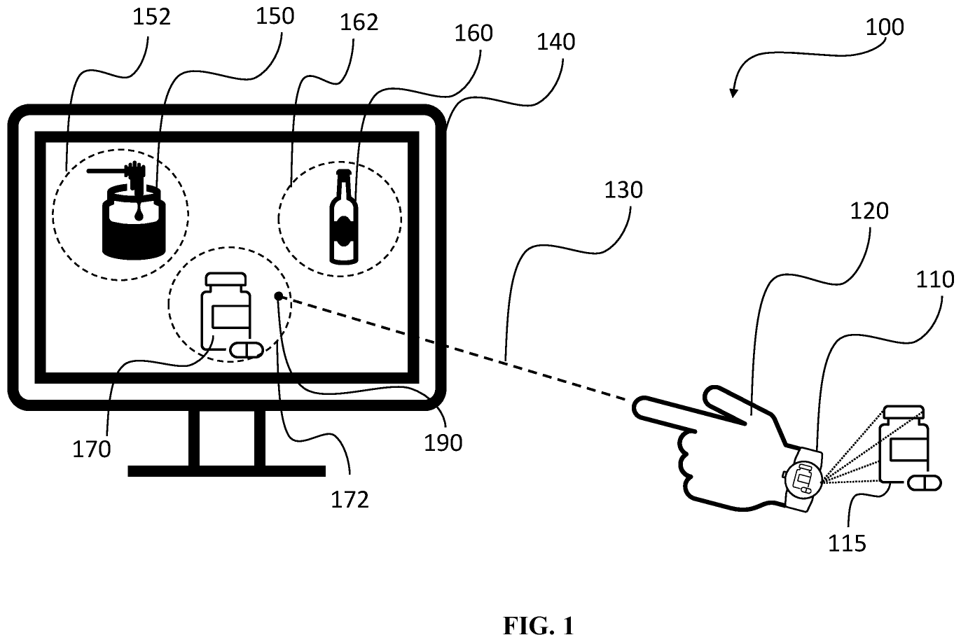

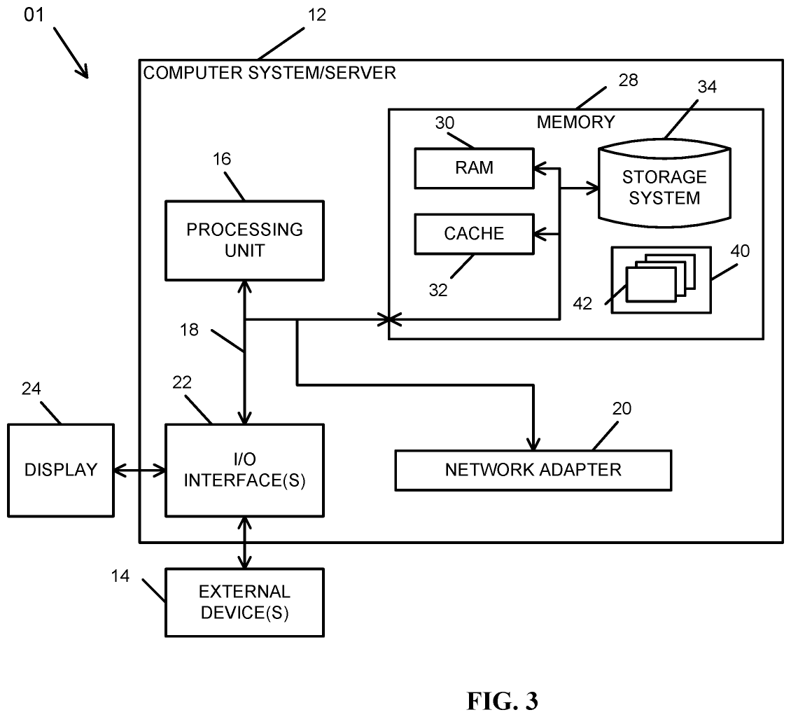

FIG. 1 depicts example gesture system 100, which may include one or more computer systems (described in FIG. 3 below).

In some embodiments, an integrated camera, an external camera, and/or a motion sensor in the smart device may register one or more gestures by the user. For example, a camera on smart watch 110 or an external camera with a user in view may register that hand 120 is displaying two fingers. In some embodiments, system 100 may compare images taken from a camera on a smart watch to one or more images in a database for one or more gestures. For example, during a user setup, the camera may take reference pictures of the user pointing, holding up two fingers, etc., and store the reference pictures in a database. System 100 may compare a photo of a gesture to the reference pictures to determine what gesture the user is making.

In some embodiments, while watching a display 140 (e.g., a TV, a monitor, or some other type of screen) a user may make a gesture with an appendage (e.g., arm, hand 120, finger, foot, etc.) to indicate an interest in an item (e.g., item 170) depicted on the display 140. For example, a user can point a finger with hand 120 towards vitamins (item) 170 on display 140 indicating an interest in vitamins 170. Some examples of display 140 may include a TV, a computer monitor, a projector, and a tablet.

In some embodiments, a smart device, such as a smart watch, attached to the appendage may be used to extrapolate a direction of the gesture. For example, some smart devices are equipped with directional and movement sensing equipment, such as a compass, a gyroscope, vibration sensor, bioimpedance sensor, gesture sensors, muscle movement measurement sensors, and/or an angular sensor measurement sensor. In some embodiments, system 100 may use the sensing equipment to determine a location and orientation of the smart device. For example, a compass may be used to determine which direction (North, South, East, or West) a watch is facing, and an angle sensor may be used to determine at what angle the watch is being held. Thus, by determining the location and orientation of the smart device, system 100 may extrapolate the position or direction of a gesture. For example, if a finger side of a smart watch 110 is pointed directly northwest at a 30 degree angle, system 100 may infer that a finger of hand 120 is pointed directly northwest at a 30 degree angle from horizontal. In some embodiments, a calculation or table may be used to determine the gesture direction 130 in reference to the smart device position and orientation. For example, the orientation of the smart watch 110 may not be identical to that of the gesture of hand 120, thus the angle of the gesture may be −5 degrees from the angle of the smart watch.

In some embodiments, the smart device may determine a position/location and orientation of a display. For example, display 140 may send the display coordinates to the smart watch 110, the smart watch may use triangulation of a signal to determine the location, the smart watch may use an integrated camera to determine a location, the display may send an infrared signal to the smart watch, or another method of determining the location and orientation of the display. In a more specific example, display 140 may give its precise GPS coordinates as an orientation of 20 degrees (where due north is 0 degrees, and due south is 180 degrees).

In some embodiments, a camera on the smart device may detect one or more images on the screen to determine orientation. For example, display 140 may display 2 infrared dots which the camera on smart watch 110 records. System 100 may use the dots to determine an orientation of smart watch 110.

In some embodiments, the extrapolated direction of the gesture is used in conjunction with the location and the orientation of the display to determine at what point on a display a user is gesturing towards. For example, using the extrapolated direction 130 with location and orientation of display 140, system 100 is able to identify point 190 as an extrapolated direction.

In some embodiments, based on the extrapolated gesture direction towards the TV display content, the proposed system may identify a particular item selected by the user and display the item for the user. For example, system 100 may use the extrapolated gesture direction 130 to determine the user is gesturing towards point 190. Point 190 is within area 172 for vitamins 170.

In some embodiments, display 140 may send information about items 150, 160, and 170 to the smartwatch. Such information may include items' 150, 160, and 170 locations on display, the name of the items, the spatial relation of one item to another on the display, or other information. For example, the display may send the location (e.g., 7 inches from the left of the display 140 and 7 inches from the top of display 140 of the center of item 170) to smart watch 110. In some embodiments, the determination that the user is pointing to a particular product may be based on the proximity of point 190 to a particular item. FIG. 1 depicts example areas 152, 162, and 172 for example items 150, 160, and 170. In some embodiments, the particular area that indicates a positive selection of an item may be set by system 100. For example, the area may be a particular distance away from the center of the item or from the edge of the item. Other methods of determining what area of the display corresponds to a particular item may be utilized depending on the use case.

In some embodiments, once the system 100 has identified an item, the system 100 may display the item for the user. For example, smart watch 110 is displaying vitamins 170 on the smart watch display. System 100 may use other display techniques, such as a holographic display 115, a projection, or even displaying the item on another device (e.g., a mobile phone).

In some embodiments, system 100 may adjust the extrapolation of the gesture direction based on user input. For example, system 100 may prompt the user to determine if system 100 has selected the correct item. In some embodiments, the input may be a prompted user response. For example, system 100 may initialize by entering a calibrating mode. Some possible steps of the calibration mode may include asking the user what item the user is pointing at, asking a user to identify an area of the display the user is pointing to, and/or asking a user to point to a certain area of the display. In some embodiments, system 100 may calibrate during operation based on the user actions. For example, if the user is consistently pointing two inches to the right of items, system 100 may adjust the extrapolation two inches to the left. In another example, if system 100 selects and displays vitamins 170 in response to a gesture, and the user immediately moves the gesture to the left and up, towards item 150, system 100 may adjust the extrapolated direction 130 to the left and up for future user gestures.

In some embodiments, system 100 may actively monitor the user input and display products as they are selected. For example, the user may first select (with a gesture as described above) vitamins 170, then select drink (item) 160, and then select item 150. The displayed item on smart watch 110 may be actively updated as each item is selected.

In some embodiments, system 100 may display one or more options for an item. For example, smart watch 110 may give the user an option to open an informational page on the item, purchase the item, and/or load the item into a queue such as a shopping list. In a first example, after determining that the user has selected vitamins 170, smart watch 110 may give the user the option to open a web site listing the composition of the vitamins. In another example, after determining that the user has selected drink 160, system 100 may give the user the option to purchase drink 160.

In some embodiments, after prompting the user for an option, the smart device may register a gesture as a response to the option. For example, after displaying an item, smart watch 110 may register a thumb-up gesture by hand 120 as a positive response to the prompted option and a thumb down as a negative response to the prompted option. In a specific example, after system 100 has displayed vitamins 170 and prompted the user with the option to purchase vitamins 170, system 100 may record a thumbs up sign as a confirmation that the user wants to purchase vitamins 170 and subsequently purchase vitamins 170 for the user. The item may be purchased using the user's credentials such as financial information or account information. In some embodiments, financial information is registered or linked to system 100 by a user profile. In some embodiments, profile information is encrypted. In some embodiments, users may opt-in or opt-out of having their profile or financial information accessed by system 100. In some embodiments, system 100 may record specific gestures as conveying further information regarding the option. For example, hand 120 may hold up two fingers, shake twice, or make a thumbs up motion twice to indicate an intention of buying two items

In some embodiments, the display on the watch may be augmented with audio information to give information on the selected item, to present item options, and/or to confirm an option selection. For example, following the user selection of vitamins 170, system 100 may synthesize a voice saying, “do you want to buy exempli gratia vitamins?” After selecting yes, system 100 may synthesize a voice saying “confirmed, you have purchased one unit of exempli gratia vitamins.”

In some embodiments, system 100 may receive audio information from a user. The audio information could be an annotation of the user selection, a quantity of items, an affirmation or denial of the selection, and/or a modification to the selection. In an example of an annotation, the user could say “more information,” to indicate a desire for the product information page. In an example of denial, after prompting the user to purchase an item, the user could say “no” to indicate that the user does not want to purchase the item. In an example of a modification, where the user has selected brand A of an item, the user could say “buy brand B of the item” to indicate that he wants to purchase a different brand.

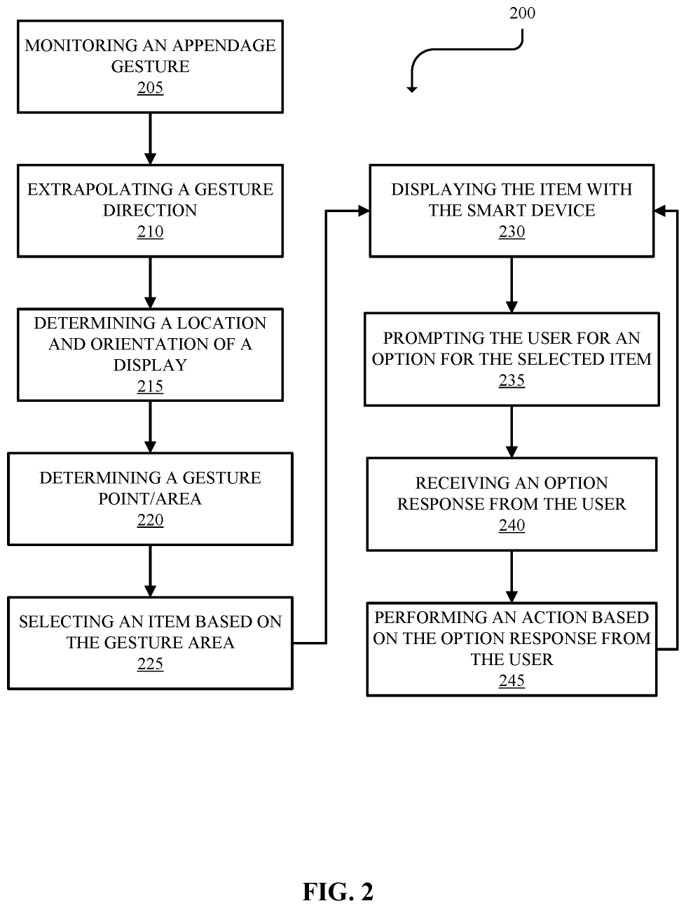

FIG. 2 shows an example method 200 of item selection using gestures for displayed items. Operations of method 200 may be enacted by one or more computer systems such as the system described in FIG. 3 below.

Method 200 begins with operation 205 of monitoring an appendage gesture. In some embodiments, a smart device may monitor an appendage for one or more gestures. For example, a gesture may be initiated based on one or more gesture triggers. For example, a gesture trigger may be a specific set of movement by the appendage and recorded by one or more sensors. As discussed above the one or more sensors may include a camera, a gyroscope, muscle movement measurement sensors, and/or an angular sensor measurement sensor, among others. For example, the system may identify the beginning of a gesture if a smart device senses a hand moving up quickly and stabilizing in a general direction of a display.

Method 200 continues with operation 210 of extrapolating a gesture direction. In some embodiments, based on the smart device sensors, the system may determine a direction of the gesture. For example, if the finger side of the smart watch is pointing at 30 degrees (where north is zero degrees and south is 180 degrees), at sea level, and angle of 5 degrees above horizontal, the system may determine that a pointing gesture of the hand is pointing at 30 degrees, at sea level, and angle of 5 degrees above horizontal. Other methods of determining location and orientation are possible. The system may have other sensors that are able to aid in the determination of the gesture without departing from the scope of this method. For example, one or more external cameras, connected to the system wirelessly, may aid in the determination of the orientation and location of the gesture.

Method 200 continues with operation 215 of determining a location and orientation of a display. For example, display 140 may send the display coordinates to the smart watch 110, the smart watch may use triangulation of a signal to determine the display location, the smart watch may use an integrated camera to determine a display location, the display may send an infrared signal to the smart watch, or another method of determining the location and orientation of the display. In a more specific example, display 140 may give its precise GPS coordinates and an orientation of 20 degrees off of southwest.

Method 200 continues with operation 220 of determining a gesture point/area on the display, based on the extrapolated gesture direction. In some embodiments, the extrapolated direction of the gesture is used in conjunction with the location and the orientation of the display to determine at what point on a display a user is gesturing towards. For example, by obtaining a precise gesture direction and knowing a precise position and orientation of a display, the system may determine what area on the display the gesture is pointing towards.

In some embodiments, the system may also register a user drawing a contour on the display to select one or more objects. For example, the user may move the gesture in a circle, and the system may use the moving extrapolated direction from the moving gesture to determine the contour the user is drawing.

Method 200 continues with operation 225 of selecting an item based on the gesture area. In some embodiments, based on the extrapolated gesture direction towards the display content, the proposed system may identify a particular item selected by the user and the smart device may display the item for the user. For example, the system may use the extrapolated gesture direction to determine the user is gesturing towards a point on the display. In some embodiments, the system may identify one or more items graphically displayed on the display and set boundary areas or designated areas for each item on the display. For example, the system may set a ten centimeter radius circle as a designated area in the center of each item on the display. When the system determines that the user is gesturing anywhere in a designated area for an item, the system may select the item. Alternatively, the system may set a radius around a gesture point, and any item that is within the radius may be selected. In some embodiments, more than one item may be selected. This may be performed when two items are in the radius around the gesture point. In some embodiments, the item that is closest to the gesture point may be selected. For example, if two items are within the radius the closest item to the gesture point may be selected. In some embodiments, the display may generate item information for the items displayed and send the information to the smart device. For example, the display may have metadata attached to a feed for the broadcast being displayed and may use that metadata to generate information for the item to provide to the smart device. The metadata a may contain information such as a placement of an item in a video feed, a name of the item, a retailer for an item, a cost of an item, alternative brands for an item, and etc. In some embodiments, the display sends a location for the items displayed to the smart device. For example, the screen may give a location of each item on the display. In a more detailed example, a display may send item 1 location [3 inches from left 3 inches from top], item 2 location [6 inches from left 6 inches from top], and item 3 location [9 inches from left 3 inches from top]. Other methods of determining where items are displayed on the display are possible.

In some embodiments, the system may identify objects present inside a user drawn contour on the display. For example, if a user draws a contour around or partially including two objects with a gesture (similar to the method for determining a point above), the system may select both objects as a selected items.

Method 200 continues with operation 230 of displaying the item with the smart device. In some embodiments, once one or more items are selected, the smart device may display the one or more items. In some embodiments, the system may use one or more display techniques, such as graphical display on the smart device, a holographic display, a projection, or even displaying on another device (e.g., a mobile phone). In some embodiments, the image for the displayed item may be from an online shopping portal, an item depiction database, an informational Internet site, or a cropped image from the display the user is pointing at. For example, a holographic projection may receive a 3D object of the selected product from an online shopping portal. In some embodiments, the display may send images of the items to the smart device. For example, the display may crop an image of a screen shot and send the cropped image to the smart device.

Method 200 continues with operation 235 of prompting the user regarding an option for the selected item. In some embodiments, options may include the capability to purchase the selected item, display information on the selected item, add the selected item to a shopping cart, query how many items should be added to the cart, display alternative items, and/or add the selected item to a favorites list. For example, the system may search for the selected item in an online shopping portal and display the shopping portal product details. Further, the system may give the user the option to add the selected item to a shopping cart for the user. In some embodiments, the system may retrieve the user information for the shopping portal and then use the retrieved information to enhance the options. For example, if the user has a profile in the shopping portal (e.g., an E-commerce portal) the system may add the selected item to the shopping cart for the user in the shopping portal. In an alternative example, if the user does not have a profile for the shopping portal, the system may prompt the user to create a profile for the shopping portal.

Method 200 continues with operation 240 of receiving an option response from the user. In some embodiments, the system may accept a gesture, inferred by readings/data from one or more sensors on the smart device, to indicate an option response to a prompted option. For example, some acceptable gestures may include a thumbs up for approving a purchase, a thumbs down for not adding the selected item to the shopping cart, a number of fingers to indicate how many items should be purchased, and/or a closed fist to indicate that the user wishes to not see any further information/options regarding the selected item. In some embodiments, the system may accept audible commands from the user or smart device interface commands as an option response. For example, when prompted to purchase a product, the user may say yes, hit a yes button on a graphical interface for the smart device, and/or scroll a wheel to change the number of items selected.

Method 200 continues with operation 245 of performing an action based on the option response from the user. For example, after receiving a user option response the system may enact an action based on the user option response. Some possible actions may include purchasing the selected item based on the user selecting a yes button, and/or adding a number of selected items to a shopping cart based on the number of fingers the user has extended.

In some embodiments, operations 230 through 245 may be repeated for each item selected.

In an exemplary embodiment, the system (e.g., system 100) includes computer system 01 as shown in FIG. 3, and computer system 01 may perform one or more of the functions/processes described above. Computer system 01 is only one example of a computer system and is not intended to suggest any limitation as to the scope of use or functionality of embodiments of the present invention. Regardless, computer system 01 is capable of being implemented to perform and/or performing any of the functionality/operations of the present invention.

Computer system 01 includes a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 12 may be described in the general context of computer system-executable instructions, such as program modules, being executed by a computer system. Generally, program modules may include routines, programs, objects, components, logic, and/or data structures that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computer system 01 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As is further depicted and described below, memory 28 may include at least one program product having a set (e.g., at least one) of program modules that are configured to carry out the functions/operations of embodiments of the invention.

Program/utility 40, having a set (at least one) of program modules 42, may be stored in memory 28 by way of example, and not limitation. Exemplary program modules 42 may include an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the present invention.

Computer system/server 12 may also communicate with one or more external devices 14 such as a keyboard, a pointing device, a display 24, one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A system comprising:
a memory; and
a processor in communication with the memory, the processor being configured to perform processes comprising:
monitoring an appendage gesture with a smart device,
wherein the gesture is a contour around an item on a first display,
extrapolating a moving gesture direction with the smart device,
monitoring, the moving extrapolated direction to determine a placement of the contour on the display,
selecting an item on the first display based on the gesture direction,
displaying the item and purchase metadata for the item on a second display on the smart device, and
connecting the smart device to an online portal for purchasing the item; and
giving a user an option to purchase the item.

2. The system of claim 1, the process further comprising:
prompting a user for an option;
receiving an option response from the user; and
performing an action based on the response.

3. The system of claim 2,
wherein the option response is a second appendage gesture.

4. The system of claim 3,
wherein the second appendage gesture indicates a number of items.

5. The system of claim 1,
wherein the displaying the item on a second display includes projecting a holographic image with the smart device.

6. The system of claim 1, the process further comprising:
determining a location and orientation of the first display.

7. The system of claim 1, the process further comprising:
determining a gesture area on the first display based on the gesture direction, the location of the first display, and orientation of the first display, wherein the selecting is based on a location of the item in reference to the gesture area.

8. A method comprising:
monitoring an appendage gesture with a smart device;
wherein the gesture is a contour around an item on a first display,
extrapolating a moving gesture direction with the smart device,
monitoring, the moving extrapolated direction to determine a placement of the contour on the display;
selecting an item on the first display based on the gesture direction;
displaying the item and purchase metadata for the item on a second display on the smart device; and
connecting the smart device to an online portal for purchasing the item; and
giving a user an option to purchase the item.

9. The method of claim 8 further comprising:
prompting a user for an option;
receiving an option response from the user; and
performing an action based on the response.

10. The method of claim 9,
wherein the option response is a second appendage gesture.

11. The method of claim 10,
wherein the second appendage gesture indicates a number of items.

12. The method of claim 8,
wherein the displaying the item on a second display includes projecting a holographic image with the smart device.

13. The method of claim 8 further comprising:
determining a location and orientation of the first display.

14. The method of claim 8 further comprising:
determining a gesture area on the first display based on the gesture direction, the location of the first display, and orientation of the first display, wherein the selecting is based on a location of the item in reference to the gesture area.

15. A computer program product comprising a computer readable storage medium having program instructions embodied therewith, the program instructions executable by a processor to cause the processors to perform a method, the method comprising:
monitoring an appendage gesture with a smart device;
wherein the gesture is a contour around an item on a first display,
extrapolating a moving gesture direction with the smart device;
monitoring, the moving extrapolated direction to determine a placement of the contour on the display;
selecting an item on a first display based on the gesture direction;
displaying the item and purchase metadata for the item on a second display on the smart device; and
connecting the smart device to an online portal for purchasing the item; and
giving a user an option to purchase the item.

16. The computer program product of claim 15, the method further comprising:
prompting a user for an option;
receiving an option response from the user; and
performing an action based on the response.

17. The computer program product of claim 16,
wherein the option response is a second appendage gesture.

18. The computer program product of claim 17,
wherein the second appendage gesture indicates a number of items.

19. The computer program product of claim 15,
wherein the displaying the item on a second display includes projecting a holographic image with the smart device.

20. The computer program product of claim 15, the method further comprising:
determining a location and orientation of the first display.
